(19) United States
(12) Patent Application Publication
(10) Pub. No.: US 2013/0215433 A1
(43) Pub. Date: Aug. 22, 2013

(54) HOVER CMM

(71) Applicant: Stephen James Crampton, London (GB)

(72) Inventor: Stephen James Crampton, London (GB)

(21) Appl. No.: 13/878,888

(22) PCT Filed: Oct. 12, 2010
(86) PCT No.: PCT/GB10/01894

§ 371 Date: Apr. 11, 2013

(51) Int. Cl. G01B 9/02; B64C 17/00

(52) U.S. Cl. CPC G01B 9/02; B64C 17/00
USPC 356/500; 356/614; 701/8

(57) ABSTRACT

It is a purpose of this invention to provide a Hover CMM to accurately measure an object. The Hover CMM comprises: a probe, an air vehicle and a localiser. The probe is mounted on the air vehicle. The air vehicle transports the probe around the surface of the object. The localiser tracks the position and orientation of the probe. The air vehicle is capable of hovering, slow and rapid movement. The measurements made by the probe are synchronised with the measurements made by the localiser. In a further embodiment, multiple probes, multiple air vehicles and multiple localisers can be provided in a system. In a further embodiment, the air vehicle has additional propulsion means for reducing wander. In another embodiment, the air vehicle is tethered. In a further embodiment, a gantry is provided for tethering the air vehicle. In another embodiment, a tilting means is provided to incline the probe relative to the air vehicle. Methods are provided for measuring an object and for controlling the wander of the air vehicle.

### FIELD OF THE INVENTION

The present invention concerns apparatus and method for a Hover CMM that accurately measures an object, in which a probe is mounted on an air vehicle and the location of the probe is tracked by a localiser. The industries with the biggest requirement for a Hover CMM are automotive, aerospace and engineering.

### BACKGROUND TO THE INVENTION

The demand for coordinate measurement machines (CMMs) for the accurate measurement of objects is well established. A CMM usually comprises at least the following: a probe, a localiser for measuring the position of the probe and a probe transport for moving the probe with respect to the object being measured.

### Probe

Many types of probe have been used as part of a CMM. For dimensional measurement, there are contact and non-contact probes. Contact probes types include touch-trigger and analogue. Non-contact probe categories utilise a variety of optical and electro-magnetic techniques. Non-contact probes are provided in trigger and analogue types. They can measure single points one at a time or multiple points simultaneously. Quantities such as temperature, thickness, surface finish, colour, vibration, hardness, density, flaws can be measured using quantity measuring probes. CMMs are also used with probe tools for performing an operation such as marking out; painting; material removal; surface treatment and joining.

### Localiser

A localiser is used to measure the position and orientation of the probe to a high accuracy in six degrees of freedom. There are two main categories of localiser: mechanical localisers and remote localisers. Mechanical localisers maintain a continuous mechanical path, with one or more axes of movement, between the probe and the base on which both the localiser and the object being measured rest. Mechanical localisers include: horizontal arm CMMs, bridge CMMs, anthropomorphic CMMs and manual anthropomorphic CMMs. Remote localisers have air between the localiser base unit and the probe. Remote localisers include: optical light trackers using triangulation, laser interferometric trackers, magnetic trackers and local wireless systems such as GPS.

### Probe Transport

A probe transport provides motive force and guidance to move the probe relative to the object being measured. There are two main types of probe transport guidance: manual guidance by an operator and automated guidance by a computer. Probe transport motive force can be provided manually by an operator, by an operator with power assisted tele-operation and by a type of servoed power moving a mechanical probe support mechanism. In a fixed cell on an automotive line, a large number of probes are provided in fixed locations and orientations on a rigid structure for measuring known features; in this case there is no probe transport.

### Integrated Localiser and Probe Transport

Often the Localiser provides integrated Probe Transport. Measurement of the position and orientation of the probe and probe transport are integrated within the same apparatus. When the probe moves, part of the localiser moves with it. This is the case for Horizontal arm CMMs, bridge CMMs, anthropomorphic CMMs and robots. Probe motive force and guidance can be any combination of manual, tele-operation and automation such as Computer Numerical Control (CNC).

### Separate Localiser and Probe Transport

The most common separation of localiser and probe transport occurs when the operator manipulates the probe and the probe is tracked with a remote localiser.

Line of sight

Most remote localisers, especially optical localisers, require a line of sight between the probe and the optical localiser. The position and orientation of the probe can be measured in 6 degrees of freedom (6-DOF). The most common approach for achieving 6-DOF measurement uses markers. The probe has a significant number of markers mounted around it for viewing from many different orientations. The markers can be active or passive. The markers are rigidly attached to the probe. Triangulation based optical localisers use the markers for all 6-DOF. An example is the Optotrak optical tracker from Northern Digital Inc. Leica Geosystems provide an AT absolute tracker, using a laser interferometer with retroreflector for measuring position (distance and angle) and an integrated camera viewing the markers for measuring probe orientation. Optical trackers require that the laser interferometer beam that tracks the retro-reflector acquire the retro-reflector in a process by which an operator manually moves the retro-reflector until it is in the beam of the tracker, and the tracker automatically tracks it after it has been recognised. Each retroreflector is typically limited in operation to 45 degs orientation from the laser interferometer beam. A probe often has several retro-reflectors mounted on different sides of the probe. The retro-reflectors are registered to each other in a qualification process. Triangulation based optical localisers view a large area and do not have this acquisition issue. Maintaining line of sight whilst moving around the object is easily solved with manual operation. The operator learns not to interpose his body or the object or orientate the probe such that line of sight is lost. Optical laser interferometer trackers maintain high accuracy for distances in excess of 75 metres. Triangulation optical localisers work in a limited area of typically 1-4 metres in any one direction. Automated Precision Inc (API) have a ‘Smarttrack’ sensor that locks onto the laser interferometer beam and provides 6-DOF output. It is heavy and has limits to its Roll, Pitch and Yaw.

### Accuracy

The accuracy of current CMMs for measuring objects of sizes greater than 500 mm in the largest dimension is of the order of from 1 micron to 500 microns. For objects the size of motor cars, a measurement accuracy of the order of 50 microns can be achieved.

### Market

The requirements of the CMM market cover a wide range of diverse applications. Almost all combinations of localiser and probe transport have been developed and marketed at some point in the past. An exhaustive list of all products and prototypes is not provided, since it is assumed that a person skilled in the area and with knowledge of the CMM market, will know or quickly understand the application and advantages/disadvantages of each type. The requirements of the market for CMM application are so diverse that many of the combinations are still available and competitive in the marketplace. Current trends are towards non-contact probes and towards remote localisers. Almost every new solution finds one or more niche applications. The requirements driving invention and innovation are:
novel, higher utility ways of solving a new or existing application
more flexible and accessible systems eg smaller, lighter systems with less cabling
higher accuracy of measurement
increased speed of measurement
lower cost
increased ease of use
more automation and reduced manpower
more compact and lighter systems
portability of bringing the CMM to the object being measured
larger and more accurate measuring range for bigger objects

### Current Situation

The vast majority of CMMs are either heavy and automated, or light and manual. A system that is light and automated would provide increased utility by better satisfying many of the market requirements listed above.

### Air Vehicles

Micro air vehicles (MAVs) that are radio controlled and can hover are being marketed. There are airframe designs available including ducted fans, helicopters with a main rotor and a stabilising rotor, twin-rotors, quad-rotors, 6-rotors and 8-rotors. Their weights range typically from below 20 g to in excess of 10,000 g. Their sizes range from less than 100 mm to over 600 mm in the largest dimension. MAVs are typically controlled manually by radio control (RC). MAVs include an autopilot that can achieve the resulting motion demanded by the RC and put the air vehicle into a stable hover if no demand is communicated. Recently, some air vehicles have been developed that use the GPS satellite system for navigation and can be program controlled. A group led by Assistant Professor Jonathan How at Massachusetts Institute of Technology (MIT), Boston, USA has developed a system for controlling quad-rotors using RC's controlled by a computer program. It uses a low-accuracy optical tracking system from Vicon, Oxford, UK for position feedback. Different airframes have different stabilities, but the best can maintain a point hover to within +/−50 mm location wander of the desired point. The MIT group have also demonstrated automated vertical landings.

### SUMMARY OF TILE INVENTION

It is a purpose of this invention to provide a novel Hover CMM with an air vehicle for probe transport and an optical localiser. In a first embodiment of the present invention, the Hover CMM comprises an air vehicle; a probe mounted on the air vehicle and an optical localiser for measuring the position and orientation of the probe, operable such that measurements of an object are made. In a second embodiment of the present invention, the air vehicle has additional propulsion means for reducing wander. In a third embodiment of the present invention, the Hover CMM comprises an air vehicle that is tethered. In a fourth embodiment of the present invention, the Hover CMM further comprises an axis for tilting the probe. In a fifth embodiment of the present invention, the probe mounted on the air vehicle performs an operation on the object.

### BRIEF DESCRIPTION OF THE DRAWINGS

Embodiments of the present invention will now be described, by way of example only, with reference to the accompanying drawings, in which:

FIG. 1 is a schematic layout of a Hover CMM in accordance with a first embodiment of the present invention;

FIG. 2 is a schematic layout of an air vehicle with additional rotors in accordance with a second embodiment of the present invention;

FIG. 3 is a schematic layout of a tethered Hover CMM in accordance with a third embodiment of the present invention;

FIG. 4 is a schematic of an air vehicle with tilting probe CMM in accordance with a fourth embodiment of the present invention.

### DETAILED DESCRIPTION OF THE PREFERRED EMBODIMENTS

### First Embodiment

### Hover CMM

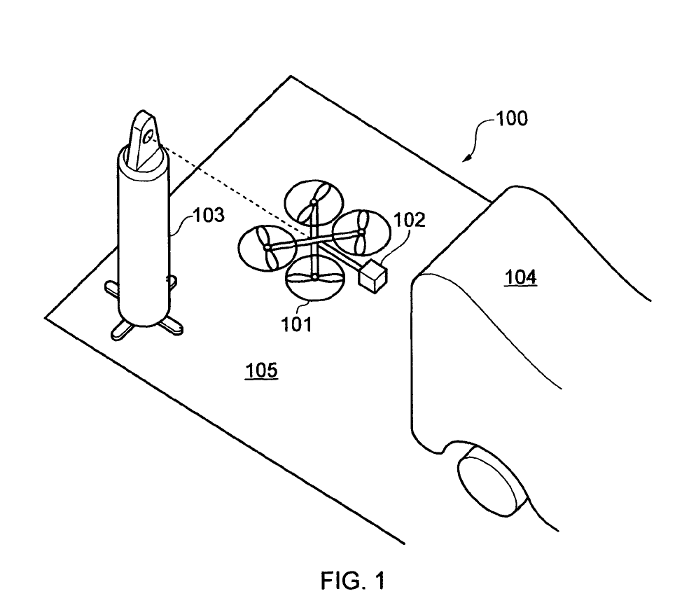

The first embodiment of the Hover CMM invention is now disclosed. FIG. 1 is a schematic layout of a Hover CMM 100 in accordance with a first embodiment of the present invention. A probe 102 is mounted on an air vehicle 101 that transports the probe 102 around an object 104. An optical localiser 103 tracks the probe 102. The probe 102 takes measurements of an object 104. The localiser 103 and the object 104 are located on a base 105.

### Air Vehicle

The air vehicle 101 is small and lightweight. The air vehicle 101 is a quad-rotor with four rotors in a geometric plane. One opposing pair of rotors rotates clockwise and the other opposing pair of rotors rotates anti-clockwise. An autopilot controls the rotors to provide movement of the air vehicle in a demand direction/orientation or a hover based at a demand location/orientation. When hovering, the position of the air vehicle 101 in the air can be controlled with a typical location wander error of +/−100 mm. The accelerations in all 6 degrees of freedom can be controlled to be low. The shake of the air vehicle in the air is of the same order as the shake of a human holding a probe in a conventional manual CMM system. The rotors are driven by electric motors. The electric motors are preferably brushless for longevity and more efficient operation. The air vehicle 101 has a battery. Spare batteries are provided. A battery charger is provided if the batteries are rechargeable. The air vehicle 101 has a wireless communications system such as WiFi for sending/receiving control signals and data. The electric motors can be mounted to the air vehicle 101 rigidly or with a vibration absorption device.

### Probe

The probe 102 is preferably a non-contact probe. A variety of probes 102 operate with the air vehicle 101 for measuring dimensions and quantities. More than one probe 102 can be mounted on the air vehicle 101 at the same time and each of these more than one probes 102 can operate at any time including one or more probes 102 operating simultaneously.

### Multi-Probe Registration

When there are more than one probes 102 on an air vehicle 101, the more than one probes 102 can be registered to each other such that the optical tracking of one probe 102 automatically gives the position and orientation of all of the probes 102. An independent probe 102 is defined as either one probe 102 or more than one probes 102 registered to each other on the same air vehicle 101. The scope of this Hover CMM is not limited to any types or quantities or groupings of probes 102 but may include any probe types and arrangements that are useful.

### Localiser

The localiser 103 is preferably an optical localiser. For larger objects 104 the optical localiser 103 is preferably a laser interferometer tracker and for smaller-medium sized objects 104 the optical localiser 103 is optionally a triangulation optical localiser. More than one 6-DOF localiser 103 can operate in a Hover CMM system 100. For example, when scanning a car, four localisers 103 can be used, one stood off from each corner of the car. Preferably there is at least one localiser 103 for each independent probe 102. The scope of this Hover CMM is not limited to any types or quantities or arrangements of localisers 103 but may include any localiser types, quantities and arrangements that are useful.

### Line of Sight

Optical localisers 103 require a continuous line of sight with the independent probe 102. With large and complex objects 104 it is sometimes difficult to initially set up the localiser 103 such that there is a continuous line of sight for all positions of the independent probe 102 whilst it is measuring or being traversed between measuring positions. Line of sight can be interrupted by the interposition of part of the air vehicle 101 or the object 104 between the localiser 103 and the independent probe 102. In order to increase the robustness and flexibility of the Hover CMM system 100, more than one localiser 103 can be used with an independent probe 102. When more than one localiser 103 is provided with an independent probe 102 and if line of sight between one localiser 103 and the independent probe 102 is interrupted, measuring can continue with the line of sight to another localiser 103. The programmed path that the air vehicle 101 follows can be prepared such that line of sight is not lost.

### Synchronisation

The optical localiser 103 and the independent probe 102 have a synchronisation system. Synchronising the timing of position reading by the optical localiser 103 and by the probe 102 is important for obtaining high accuracy of measurement. One way of providing synchronisation, is for the probe 102 to emit a light pulse as a synchronisation signal to trigger a related measurement in the optical localiser 103. An optical sensor on the optical localiser 103 is arranged with line of sight to the probe 102 to receive the light pulse from the probe 102. The process of receiving the light pulse and triggering a related measurement by the optical localiser 103 is designed so that the timing difference between the time of measurement in the probe 102 and the time of related measurement in the optical localiser 103 is ideally much less than 1 microsecond. There are many ways of providing synchronisation as will be known to those skilled in the art. For example, electro-magnetic radiation such as wireless signals could be used. Synchronisation methods include any pre-synchronisation method, any real-time synchronisation method and any post-synchronisation method. Pseudo-synchronisation can be provided where measurements are made regularly but independently by the probe 102 and the optical localiser 103. Accurate clocks are provided on the probe 102 and the optical localiser 103. Measurements are time-stamped and can also be labelled. A process of interpolation is used to provide pseudo-synchronised data. The scope of this invention is not limited to the synchronisation methods disclosed here, but includes any method of combining data from the probe 102 and the optical localiser 103 with negligible error due to timing.

### Base and Environment

For accurate measurement, it is essential that the object 104 and the localiser 103 are on a base 105 that is stiff and insulated from vibrations, such as those caused by large machines or heavy transportation vehicles in the vicinity. It is preferable that the base 105 is floating and insulated from the ground by use of a vibration absorption layer. It is a benefit of this Hover CMM invention compared to the state of the art, that there are no heavy moving columns that strain the base 105, and that the base 105 can be comparatively light. In an alternative embodiment of the present invention, the base 105 is the ground. The present invention 100 is preferably operable indoors where temperature and air conditions can be controlled. The current invention can be operated outside in zero or low-wind conditions, clear air and preferably with no direct sunlight, but the object will usually change in size as the temperature changes during the day.

### Portability

Localisers 103 weigh around 10-100 kgs and are designed to be portable. The air vehicle 101 and probe 102 together weigh around 1 kg but can weigh significantly more or significantly less. A transportation case is provided for the air vehicle 101, probe(s) 102 and associated equipment such as the user interface.

### Programming

A program for measuring an object 104 is taught by manually moving an air vehicle 101 with independent probe 102 around the object 104 whilst being tracked by localiser 103. Teach programming is a process well known by those skilled in the art and it will be appreciated that providing this capability is a straightforward development task. The program that has been taught, can then be executed automatically. A dummy air vehicle 101 with probe 102 can be used for teaching instead of a real air vehicle 101 with probe 102. The disclosed method of teach programming is just one method of programming a program for automated execution. Visual feedback may be provided of measurements made on a display in substantially real-time during teaching. The scope of this invention is not limited to any one type of programming, but includes any type of programming, whether pre-programmed or generated in near real-time. For example, a commercially available inspection programming system could be configured for automatically or semi-automatically generating an inspection program of a known object for which a CAD model exists; Delcam plc supply the ‘Power Inspect’ inspection programming system and Hexagon Metrology supply PC-DMIS.

### Coordinate Systems and Registration

There are several coordinate systems in this Hover CMM 100 invention. These can include but are not limited to none, one or several of each coordinate system: global coordinate system, object coordinate system, localiser coordinate system, air vehicle coordinate system and probe coordinate system. Methods of registration are provided for establishing the precise transformation matrices between different coordinate systems required for the operation of the Hover CMM 100 invention. Methods of registration and establishing transformation matrices are well known to a person skilled in the art. The scope of this invention is not limited to any number, type of coordinate systems or registration methods.

### Probe Mount

The independent probe 102 is attached to the air vehicle 101. In a preferred embodiment, a vibration absorbing mount is interposed between the air vehicle 101 and the independent probe 102. The vibration absorbing mount damps vibrations generated by the propulsion system in the air vehicle 101, such that the independent probe 102 vibrates to a lesser extent than the air vehicle 101. This will improve the accuracy of each measurement by the probe 102. The vibration absorbing mount can be made of rubber. The independent probe 102 can have a standard mounting half of one sex and the air vehicle 101 can have a standard mounting half of the opposite sex such that any one of a number of different probes 102 can be mounted to the standard mounting half of one sex. The mount can be repeatable to a high degree of accuracy. The mount can have a device to transfer power, signals and data across it. The transfer device can be contact or non-contact. A multi-probe mount can be provided to which several probes 102 can be mounted, prior to the multi-probe mount being mounted to the air vehicle 101. The mount is lightweight. The mount can include features provided by any other probe mounts that have been disclosed in the past. The scope of this invention is not limited to the mounting devices disclosed here, but includes any apparatus for mounting the probe 102 on the air vehicle 101.

### Markers and Retro-Reflectors

Markers and retro-reflectors are provided on the exterior of the probe 102 or standing off from the probe 102 on stalks. Alternatively, if the probe 102 is rigidly mounted onto the air vehicle 101, some or all of the markers and retro-reflectors can be provided on the exterior of the air vehicle 101. Markers and retro-reflectors are of sufficient number and arrangement to maximise the range of orientations of the air vehicle 101 and probe 102 at which line of sight to the localiser 103 is possible. The quantity of markers, retro-reflectors provided and their arrangement is well known by those skilled in the art. Retro-reflectors are not required by triangulation optical localisers. The scope of this invention is not limited to the markers and retro-reflectors disclosed here, but includes any arrangement of markers and retro-reflectors on the probe 102 or the air vehicle 101 or both.

### Landing Platform

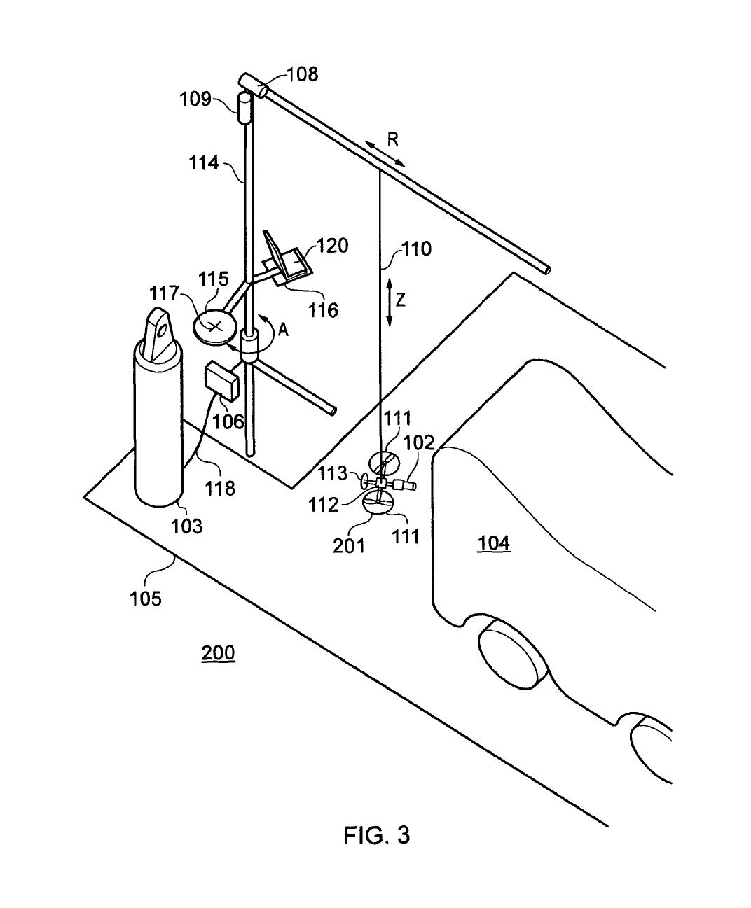

In a further embodiment of this invention, the air vehicle has a landing platform 115 (referring in this instance to FIG. 3) from which it performs automated vertical take offs and vertical landings. A bold mark such as an ‘X’ 117 (referring in this instance to FIG. 3) is provided in or near the centre of the landing platform 115. A downward pointing camera on the base of the air vehicle 101 is provided. The air vehicle 101 can look for the bold mark 117 on the landing platform 115 whilst flying, using image recognition algorithms well known to those skilled in the art. Once the bold mark 117 has been recognised, an automatic vertical landing on the landing platform 115 can be performed using algorithms well known to those skilled in the art.

### Navigation

The main positional input for navigation of the air vehicle 101 is location and orientation provided by the localiser 103 in substantially real-time. The air vehicle 101 has an inertial measurement unit (IMU). The IMU combines information from a variety of sensors such as the localiser 103, X,Y,Z MEMS accelerometers, X,Y,Z MEMS gyros, pressure sensors that can indicate changes in altitude, 3-axis magnetometers and GPS sensors. The IMU combines all the navigational information in a Kalman Filter, which is well known to those skilled in the art. This sensor redundancy means that the air vehicle 101 can be navigated using the IMU, even if one or more sensors either stops providing navigational information or provides navigational information with large errors. For example, if line of sight between an optical laser tracker localiser 103 and the retro-reflector on the probe 102 is interrupted, then the IMU can still navigate the air vehicle 101. Positional input can be supplied by an intermediate accuracy GPS system in which one or more GPS sensors onboard the air vehicle 101 sense GPS signals from a global satellite system or a local network of GPS transmitters. The GPS navigational system can provide navigational backup to the localiser 103.

### Reacquisition

It is possible that the line of sight between an optical laser tracker localiser 103 and the retro-reflector on the probe 102 can be interrupted. When this happens, methods are provided for reacquisition of the laser beam of the optical tracker onto the retro-reflector on the probe 102. If a GPS system of intermediate accuracy is provided then reacquisition is achieved by stopping the air vehicle 101 and searching for it with the localiser 103. In a reacquisition method where there is no intermediate accuracy navigational input, the following steps are performed using the onboard dead reckoning sensors:
a) The laser beam is moved back to an orientation a short but known distance (eg 100 mm) prior to the point at which interruption occurred
b) Using its IMU, the air vehicle retraces its route to the known distance before the point at which interruption occurred to rendezvous with the laser beam
c) The air vehicle enters a search routine around that rendezvous point until reacquisition occurs or a fixed amount of time passes; the optical laser tracker localiser 103 will be looking for markers over a wide angle and can use those markers to calculate where it needs to move the laser beam to in order to reacquire
d) If reacquisition does not occur in a fixed time, the air vehicle 101 uses its IMU to return to above the landing platform 115
e) The air vehicle 101 then recognises and uses the bold mark 117 to automatically land in a known orientation

The optical laser tracker localiser 103 after a fixed period of time reorients the laser beam to the landing platform 115 and follows a search pattern until it reacquires the retro-reflector on the air vehicle 101

The scope of this invention is not limited by the methods for reacquisition disclosed, but applies to any automated method of reacquisition.

### Large Objects

For measuring large objects such as aeroplane wings, the localisers 103 can be mounted high up on rigid structures to get above the wing surface.

### User Interface and Networking

A user interface can be provided in all the well-accepted forms including a laptop 120 (referring in this instance to FIG. 3). Some of the functions enabled through the User Interface include setup, programming, control, monitoring and processing results. The Hover CMM 100 can have a remote interface through communication links to a remote computer such as an office computer or a home computer. A link with a company computer network can be provided for at least data download/upload. The link can connect to other networks including the Internet. The link can be wired or wireless. A flying controller interface can be provided for manual control of the Hover CMM 100 in a manner similar to radio control flying of a model aircraft.

### Safety

It is a purpose of this Hover CMM 100 invention to provide any necessary safety precautions such that there is no danger to people or equipment and such that a measuring process is not interrupted. The air vehicle 101 can be designed with flexible propellors such that any collision with a person will not result in injury. A flashing light can be provided on the air vehicle 101. The area of operation of the air vehicle 101 can be a designated safety area, protected with various sensors for sensing people crossing any open boundary. When a movement sensor is triggered, an audible warning can be given. With increasing proximity, the air vehicle 101 can be automatically landed. A high degree of safety can be achieved without physical barriers. The scope of this invention is not limited to the safety measures disclosed here, but includes any appropriate standard safety measures that have been used on automated measuring or similar systems; a risk analysis is normally performed prior to designing the safety system.

### Method

It is an object of this invention to disclose a novel method for measuring an object. In a first step, a first measurement is made of an object using a probe and a localiser at a first probe location/orientation. In a second step, an air vehicle moves the probe to a second location/orientation. In a third step, a second measurement is made of the object using the probe and the localiser at the second location/orientation. Steps 2 and 3 are repeated until measurements of the object have been made from all required locations/orientations. The scope of this invention is not limited to the method disclosed but includes all methods for measuring an object using a Hover CMM 100. For instance, in an alternative method, rather than stopping and starting, measurements are made on the fly, with the air vehicle continuously moving during the measuring process.

### Trajectory Accuracy

A feature of the Hover CMM 100 is that the probe 102 does not need to be in a precise location/orientation to make a measurement. Instead, the range, breadth and spread of measurement of the probe 102 enables useful and accurate measurements to be made from approximate locations. Another feature of this invention is that a large number of measurements will be made, such that it is more important to take measurements at short and regular intervals than for the probe trajectory to be of any significant accuracy.

### Accuracy

The Hover CMM 100 is applicable to measuring objects of substantial size such as from the automotive and aerospace industries. The overall dimensional accuracy achieved is in the range of 10-500 microns for objects greater than one metre in their largest dimension and whose maximum measured size is limited by the range of the localiser 103.

### Applicability

The Hover CMM 100 invention combines light weight and automation. This means that it is a preferable apparatus for automating a host of measuring tasks for which existing lightweight solutions are manually operated. This brings the benefits of automation including lower cost, higher repeatability and elimination of a dull, manual job.

This Hover CMM 100 invention is both automated and accurate. It fits many requirements of the automotive, aerospace industries for measurement. It is light and relatively low-cost to manufacture. Automated measurement by this Hover CMM 100 invention is performed more reliably than manual operation, because there is not an operator applying forces and torques that make measurement less accurate. On a production line, the Hover CMM 100 is lower cost to operate than a manual operator operating a Manual CMM, particularly when working a 2 or 3-shift pattern. It is expected that this Hover CMM 100 invention will be deployed as a general purpose measuring tool for a host of applications similar to the general purpose utility of conventional CNC CMMs.

Most measurement applications fall under two broad headings: reverse engineering and inspection. This Hover CMM 100 invention is applicable to all measurement applications including reverse engineering and inspection, but will see greater deployment in inspection applications because Reverse Engineering is a comparatively rare event compared to regular inspection. The following applications are listed by means of example of the utility of this invention. The application of this invention is not limited to the applications listed below.

Inspection applications
gap and flush measurement for automotive
doors
verification of dimensional tolerances
riverbed analysis
VR simulation
tooling inspection
pre-production designs
development of foams
car body inspection on production line
seat inspection on seat production line
interiors of cars in situ
engine components removed and in situ
turbine blades
housings and cowlings
gas tank inspection
glass quality analysis
interior trims
prototype assembly of cars; verifying panel
has been manually placed in the correct
position
press die
scanning of bridge support
sheet metal components: features
sheet metal components: surface shape
external pipe corrosion measurement and
pipe thickness measurement
Reverse Engineering
military parts for spares where drawings
have been lost
clay styling models for automotive designs
industrial design models
surface reconstruction
model of character or prop for
film/broadcast/computer games animation
precious artworks such as large sculptures,
statues and artefacts for archiving, research,
reconstruction and conservation
rapid prototyping
detailed objects for which it is too time
consuming and arduous to measure
manually
Other
Toy
Medical
research
teaching

A Hover CMM 100 cell with several air vehicles 101 is a superior installation to existing rigid structures of static optical probes on automotive lines. The Hover CMM 100 is more flexible for dynamic reprogramming for different car models going down the line. For optical scanning of a one-off object, a Hover CMM 100 removes hard and dull manual effort from operator. For applications involving objects that are difficult to access, a gantry is normally built to let the operator measure the object with a Manual CMM; often the operator is in an awkward position that cannot be safe and can lead to back strain. Applying this Hover CMM 100 invention will mean that measuring can be manually controlled using a hand-held control panel. This means that a gantry does not need to be built and the operator does not need to get into awkward, unsafe and unhealthy positions for measuring.

### Second Embodiment

### Air Vehicle Types

In accordance with a second embodiment of the present invention, a twin-rotor air vehicle 101 is provided that is smaller than the quad-rotor air vehicle 101. It has two rotors in a geometric plane but with separated axes to provide lift, one rotating clockwise and the other rotating anti-clockwise. The fans are driven by electric motors. The rotors are ducted. Underneath each duct, a controllable inclinable surface provides aerodynamic control. An autopilot controls the fans and inclinable surfaces to provide movement of the air vehicle in a demand direction/orientation. In a further embodiment of the present invention, a ducted fan is provided with two contra-rotating, co-axial rotors. In another embodiment of the present invention, a conventional helicopter arrangement is provided.

### Wander Reduction

It is a further purpose of this Hover CMM 100 invention, that it is useful to reduce the 6-DOF wander of the air vehicle 101 either when it is hovering or when it is path following. The location wander is defined as the statistical error (root mean square) of its location from its desired location. The orientation wander is defined as the statistical error (root mean square) of its orientation from its desired orientation. The scope of this Hover CMM invention is not limited to the disclosed means and methods of reducing location wander and orientation wander, but includes all methods of reducing location wander and orientation wander. A person skilled in the art of autopilot control can use all the usual means to reduce the location wander and orientation wander. For example, a faster navigation control loop closure time can be provided to reduce the location wander and orientation wander. The localiser 6-DOF output rate can be increased to reduce the location wander and orientation wander. Control loop gains can be optimised. More powerful motors can be provided. Rotational inertias can be changed.

The scope of this invention is not limited to the air vehicles 101 disclosed. It will be understood by anyone skilled in the art, that this invention is applicable to any air vehicle 101 that can carry a probe 102 and that can be controlled to move and to hold a hover position.

### Additional Rotors

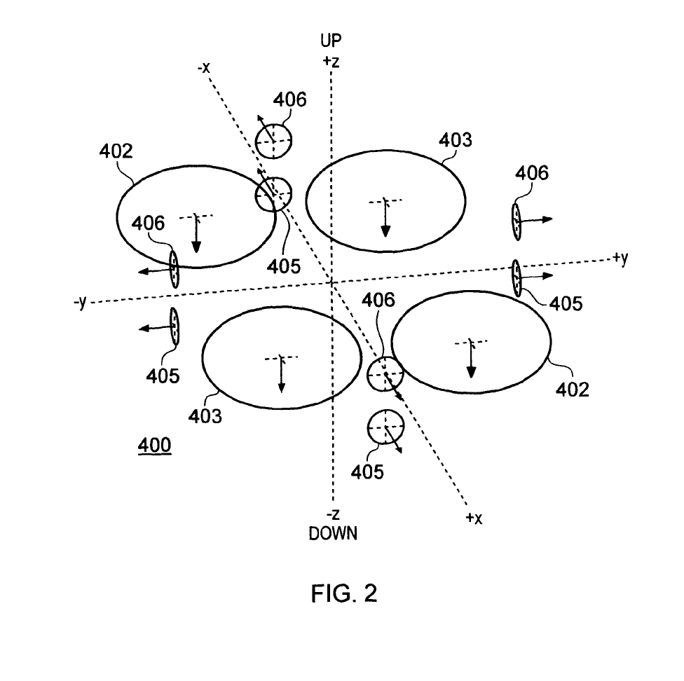

An air vehicle 101 with rotors having parallel axes and constrained, if any, control surfaces is much less easy to control wander in 6-DOF than for example a satellite in space with multiple small thrusters for accurate adjustment. In accordance with this second embodiment of the present invention, an air vehicle is provided with additional rotors for reducing wander. FIG. 2 is a schematic layout of an air vehicle with additional rotors 400 in accordance with a second embodiment of the present invention. The air vehicle with additional rotors 400 has four main rotors for providing lift; the two main rotors 402 rotate clockwise; the two main rotors 403 rotate anti-clockwise. Eight additional rotors 405, 406 are provided for controlling wander. Four of the additional rotors 405 rotate clockwise. Four of the additional rotors 406 rotate anti-clockwise. The arrows from the axis of rotation of each rotor show the direction in which air is blown by the rotors. The additional rotors 405, 406 are arranged in four pairs. Each pair comprises one clockwise rotor 405 and one anti-clockwise rotor 406. The four pairs point in the four directions +X, −X, +Y, −Y. The axes X, Y, Z pass through the centre of gravity of the air vehicle with additional rotors 400. Each pair is centred about an axis passing through the centre of gravity. All the twelve rotors are rigidly connected to a single structure (not shown) that is the vehicle frame. The rotors are preferably driven by electric motors. The additional rotors 405, 406 are significantly smaller, lighter and less powerful than the main rotors 402, 403.

The scope of this second embodiment is not limited to the exemplary disclosure, but includes all ways of providing additional means to reduce wander of the air vehicle 400. For example, the additional rotors can be ducted fans or any other form of propulsion for propelling an air vehicle. The ducted fans can have associated moving control surfaces. The ducted fans can be tillable to provide vectored thrust. Each pair of rotors can be co-axial rather than parallel axis. Very small rotors can be provided singly rather in pairs, with the torque reaction being corrected by the four main rotors 402, 403. Any number of additional rotors can be provided; three additional rotors on an 120-degree spacing are sufficient for manoeuvring the air vehicle with additional rotors 400 in the XY plane. The additional rotors of any number can be arranged in any way relative to the four main rotors 402, 403 that achieves the objective of reducing wander; the main difference being that rotors have a torque reaction and thrusters usually do not. Ways of arranging additional rotors are well known from the arrangements of translation thrusters and orientation thrusters for the control of satellites. The additional rotors can be arranged significantly off-axis to achieve orientation control of the air vehicle with additional rotors 400 about any axis (yaw, pitch or roll). The additional rotors 405, 406 must be powerful enough to achieve the desired maximum wander. Each of the additional rotors 405, 406 is typically less than 5% of the power of a main rotor 402, 403 but could be much more than 5% or much less than 5%. Embodiments with fewer additional rotors will have more powerful additional rotors than embodiments with a larger number of additional rotors. The electric motors can be brushed or brushless and controlled in any way from full servo control to simple voltage control. The structure of the air vehicle with additional rotors 400 can be flexible or resilient rather than rigid. One or more of the rotors can blow air towards the centre of the air vehicle with additional rotors 400 rather than away from it. The air vehicle with additional rotors 400 can be based on a quad-rotor, a twin-rotor, a helicopter or any of other airframe and propulsion system capable of hovering.

It is a further object of this second embodiment of the present invention to provide a control system to use the additional rotors to reduce location and orientation wander. A person skilled in the art of autopilot control can use the main rotors 402,403 and additional rotors 405, 406 on the air vehicle with additional rotors 400 and all the well-known control means to reduce the location wander and orientation wander by a factor of several times over an air vehicle 101 without additional rotors. The same person can use his skills to reduce the wander on all airframe types with additional rotors in any arrangement that can hover and provide sufficient capability for controlling to reduce wander.

An exemplary method for controlling the wander in flight of an air vehicle with main propulsion means and additional propulsion means is disclosed comprising the following steps:
[Step 1] the 6-DOF position and orientation of the air vehicle is measured using a localiser;
[Step 2] a control loop compares at least the 6-DOF position and orientation with at least the demanded 6-DOF position and orientation;
[Step 3] the control loop generates control output signals to the main propulsion means and additional propulsion means on the air vehicle to reduce the wander;
   where steps 1 to 3 are repeated until the flight terminates. Steps 1 to 3 are typically repeated at a rate between 50 Hz and 1,000 Hz, but could be less than 50 Hz or more than 1,000 Hz.

The scope of this invention is not limited to the exemplary method of controlling the wander in flight of an air vehicle with additional rotors 400 but includes all methods of controlling the wander in flight of an air vehicle with additional rotors 400. For example, the control loop can also use previous time-stamped localiser measurements, vehicle velocities, angular velocities, accelerations and angular accelerations. The control loop can be used for any of the following functions: hover with fixed orientation, hover with any orientation, location/orientation path following and location path following with any orientations. The control loop is not limited to these functions, but can be provided for any flight control function including paths with any or all of pre-determined timed waypoints, velocities and accelerations. The control loop can use data from any instrumentation such as from an inertial measurement unit (IMU).

The disclosure of an air vehicle with additional rotors 400 and methods for substantially reducing wander means that the probe 102 can follow the demanded measuring path more accurately and can be kept within the measuring range of small-range probes 102. This second embodiment makes the Hover CMM 100 more useful for accurate measuring.

### Third Embodiment

In accordance with a third embodiment of the present invention, a tethered air vehicle is provided. FIG. 3 is a schematic layout of a tethered Hover CMM 200 in accordance with a third embodiment of the present invention. A probe 102 is rigidly mounted on a tethered air vehicle 201 that transports the probe 102 around an object 104. An optical localiser 103 tracks the probe 102. The probe 102 takes measurements of an object 104. The localiser 103 and the object 104 are located on a base 105. The tethered air vehicle 201 is attached to a tether 110 hanging from a gantry 114. The gantry 114 has three axes R, A, Z powered by motors 108, 107 and 109. Axis R is a horizontal radial linear axis. Axis A is a rotational axis about a vertical axis. Axis Z is a vertical linear axis. A laptop 120 is mounted on a laptop platform 116 attached to the side of the gantry 114. The laptop 120 is connected to the gantry controller 106 by a cable. A landing platform 115 with a bold mark 117 is attached to the side of the gantry 114. A controller 106 is provided for controlling the gantry 114. The controller 106 is connected to the localiser 103 with cable 118.

### Tether

The tether 110 is attached to the tethered air vehicle 201 and is lowered/raised by the gantry 114. The tether has at least one of the following functions: lift, location, power, ground, synchronisation, control bus, data communications bus and damping. In most cases, a tether is connected to the gantry controller 106. Lifting takes some or all of the weight of the tethered air vehicle 201 and reduces the work carried out by the propulsion system of the tethered air vehicle 201. Location locates the tethered air vehicle 201 where it needs to be such that the tether 110 descends directly over the tethered air vehicle 201 or hangs in any desired position relative to the tethered air vehicle 201. Power provides all the power requirements for the tethered air vehicle 201 and the probe 102. Ground prevents the build-up of static charge by providing earthing. Synchronisation provides a wired route for the synchronisation between the probe 102 and the localiser 103. A continuous connection is provided through cable 118. Damping reduces the location wander and orientation wander of the tethered air vehicle 201 whilst flying and enables it to maintain a more accurate position. The scope of the third embodiment of this invention does not limit the tether 110 to these functions but includes all other functions or attributes of the tether 110. For example, the tether 110 may have an optimum stiffness and an optimum elasticity.

### Tether Securing End

It is a feature of this third embodiment of the present invention, that the securing end of the tether 110 (the securing end of the tether 110 is defined as the end not attached to the tethered air vehicle 201) is connected to a support device above the tethered air vehicle 201 such that some or all of the weight of the tethered air vehicle 201 can be taken by the tether. The scope of this invention is not limited to securing the tether 110 from above, but includes all other apparatus for tethering and locating the securing end of the tether 110. For example, in a further embodiment the tether 110 could hang down from the tethered air vehicle 201 with the securing end of the tether 110 secured at a fixed point on the ground. In another embodiment, the securing end of the tether 110 is secured at a point at a height above the ground and hangs in a catenary-like form between the secured point and the tethered air vehicle 201. In a further embodiment, the securing end of the tether 110 is reeled in and out automatically from a secured point such that its free length is optimal. In another embodiment, the securing end of the tether 110 is on an automated guided vehicle and can move across the ground.

### Gantry

The scope of this invention is not limited to the type of gantry herein disclosed, but includes any gantry arrangement. Servo controlled gantries can comprise 1, 2, 3 or more axes. The axes can be arranged in cylindrical, Cartesian, spherical or any other arrangement relative to each other. A tethered air vehicle 201 can be suspended from 2 or more tethers 110 with each secured end of a tether 110 fixed or independently controllable in any number of axes. Several gantries can be provided to manoeuvre several tethered air vehicles 201. The manoeuvring of the tethered air vehicle 201 can be considered to be analogous to the manoeuvring of an actor through the air in an entertainment theatre. Some theatres provide more than 50 independent and coordinated axes of movement. The arrangement of large numbers of axes and the control algorithms for their use can be carried out by someone skilled in the field such that no entanglements or other negative occurrences occur.

Parasitic gantries can be provided without any form of programmed servo control. For example, in a further embodiment of the current invention, a simple tension control system is provided to automatically pay out or coil back tether 110 in response to sensed movements of the tethered air vehicle 201. A simple tether angle measuring device can sense the angle of the tether in two components relative to the vertical axis and automatically move the secured end of the tether 110 to be vertically above the tethered air vehicle 201. Such parasitic gantries do not require a control system link to the rest of the tethered Hover CMM 200 system.

### Gantry Base

The gantry 114 can be mounted on the base 105 or preferably can be mounted adjacent to the base 105 (shown). When the gantry 114 is not mounted on the base 105, then the base 105 is not subject to any stresses or vibrations from the operation of the gantry 114 that might make the tethered Hover CMM 200 less accurate. It is a further object of this invention, that the gantry base may be on an automated guided vehicle (AGV) that moves across the ground; the number of axes of movement of the AGV and the gantry 114 for controlling the tether 110 could be 2 or more; the AGV can have the freedoms associated with any design of vehicle including but not limited to: free-roving, steerable wheels, moving along rails.

### Tether Control

It is usual that the inertia in the tether coupled with air friction forces from moving through the air, can set up a swinging motion that will affect the tethered air vehicle 201. It is an object if this invention that a control algorithm is used to move the securing end of the tether 110 and the tethered air vehicle 201 such that any swinging motion is almost completely eliminated. Such a control algorithm can be easily provided by a person skilled in the field. A device for measuring the tension in each tether 110 is provided and this measured quantity is used in the control of the tether 110. A control algorithm is provided by someone skilled in the knowledge to ensure that the tether 110 is not twisted continuously in the same direction; with this algorithm, the net rotational angle of the clockwise and anticlockwise rotations of the tethered air vehicle 201 tends to less than one complete rotation.

### Pure Suspension

In a further embodiment of the present invention, a tethered Hover CMM 200 system is provided with at least three tethers 110 for each tethered air vehicle 201 and a pan, tilt axis such for each tethered air vehicle 201 that each tethered air vehicle 201 can be moved for measurement without the use of the rotors. This embodiment has the drawback of angled tethers 110 colliding with the object 104.

### Utility

The advantages of this tethered Hover CMM 200 third embodiment of the current invention are several. Firstly, no weight of batteries need to be carried by the tethered air vehicle 201 which enables the tethered air vehicle 201 to be lighter and more compact. Secondly, due to the damping of the tether 110, the wander of the tethered air vehicle 201 is less than for an untethered air vehicle 101 and the tethered air vehicle 201 can be more precisely controlled. Thirdly, the endurance of the tethered air vehicle 201 is almost unlimited in contrast to the air vehicle 101 operating on batteries that require replacing or recharging at intervals of the order of 1 hour. The utility of this tethered Hover CMM 200 third embodiment is not limited to these advantages but includes many others.

### Fourth Embodiment

The air vehicle 101 of the previous embodiments is capable of hovering in a horizontal orientation and rotating about a vertical axis. When measuring an object 104 it is useful to point the probe 102 upwards or downwards, typically by +/−90 degrees. If the air vehicle 101 is tilted, then a side effect is that it no longer maintains a stationary hover, but accelerates in a direction with a horizontal component.

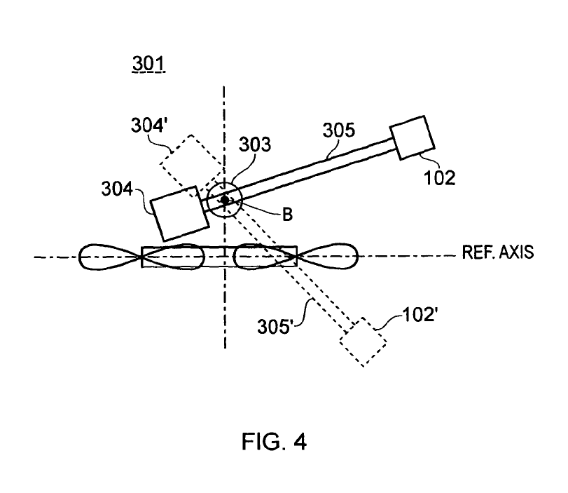

In accordance with a fourth embodiment of the present invention, a device for tilting the probe 102 relative to the air vehicle is provided such that the probe 102 can be tilted whilst the air vehicle remains in a stationary hover. FIG. 4 is a schematic layout of an air vehicle 301 with a rotational powered axis 302 for tilting probe 102 in accordance with a fourth embodiment of the present invention. A probe 102 is on a tilting beam 305 with a counterbalance 304. The tilting beam 305 rotates about axis B driven by servomotor 303. The tilting beam 305 moves to a new location 305′ and the probe 102 moves to 102′ at a different axis orientation B.

Axis B is ideally located at the centre of gravity of air vehicle 301. The counterbalance 304 is useful for reducing the torque needed in motor 303 and hence its weight. The counterbalance 304 can contain items that have to be on the air vehicle 301 such as electronics and navigation components. The tilting beam 305 places the probe 102 far enough away from the air vehicle 301 such that the air vehicle 301 can move around the object 104 without colliding with it.

The motor 303 can rotate Axis B during measurement. The rotational moment of inertia of the beam 305 and the items such as probe 102 and counterbalance 304 mounted to it, are minimised. Rotation is normally slow to minimise the torque reaction tendency to tilt the air vehicle 301. In an algorithm in the control of air vehicle 301, a compensation for the torque reaction is made by a person skilled in the field through controlling the power to the rotors of air vehicle 301 to maintain a stationary hover. All the markers and retro-reflectors must be on the probe side of Axis B.

### Fifth Embodiment

In accordance with a fifth embodiment of the present invention, the probe 102 is a tool and performs an operation on the object 104. Operations that could be performed by probe 102 on object 104 include but are not limited to marking out; painting; material removal; surface treatment and joining. During an operation, the probe 102 could be in contact with object 104 or alternatively probe 102 could be remote from the surface of object 104.

### Further Embodiments

This Hover CMM 100 invention is not limited to the devices of the disclosed embodiments but can include any form of Hover CMM 100:
for applications on a production line and particularly an automotive production line;
for applications in which the probe 102 varies in weight from a few grammes up to several kilogrammes;
for applications in which the accuracy of the Hover CMM 100 ranges from more accurate than the most accurate of today's conventional CMM machines to mid-accuracy applications;
for applications that are inaccessible to an operator without the building of temporary access structures;
for applications in which the object 104 being measured can be moved in six degrees of freedom at any time during or between measurements and that the Hover CMM 100 and the object 104 can be each moving in six degrees of freedom simultaneously, during or between measurements.

1. A coordinate measuring machine comprising:
an air vehicle;
a probe mounted on said air vehicle;
a localiser for measuring the position and orientation of said probe;
operable such that accurate measures of an object are made.

2. A coordinate measuring machine in accordance with claim 1 wherein said air vehicle is a quad- rotor.

3. (canceled)

4. A coordinate measuring machine in accordance with claim 1 wherein said air vehicle is a helicopter.

5. A coordinate measuring machine in accordance with claim 1 wherein said probe is a non-contact probe for dimensional measurement.

6. A coordinate measuring machine in accordance with claim 5 wherein said non-contact dimensional measurement probe is optical.

7. (canceled)

8. A coordinate measuring machine in accordance with claim 1 wherein said probe is a contact probe for dimensional measurement.

9. A coordinate measuring machine in accordance with claim 1 wherein said probe is a quantity measuring probe.

10. A coordinate measuring machine in accordance with claim 1 wherein said probe is tiltable relative to said air vehicle.

11. A coordinate measuring machine in accordance with claim 1 that further comprises a probe mount and said probe mount comprises vibration absorption means.

12. A coordinate measuring machine in accordance with claim 1 wherein said localiser is an optical localiser.

13. A coordinate measuring machine in accordance with claim 12 wherein said optical localiser is a laser interferometer tracker.

14. (canceled)

15. A coordinate measuring machine in accordance with claim 1 wherein said localiser is a GPS localiser.

16. (canceled)

17. (canceled)

18. A coordinate measuring machine in accordance with claim 1 wherein there is a plurality of localisers.

19. A coordinate measuring machine in accordance with any of claim 1 that further comprises a tether to said air vehicle.

20. A coordinate measuring machine in accordance with claim 19 that further comprises a gantry for supporting said tether.

21-25. (canceled)

26. A coordinate measuring machine in accordance with claim 1 wherein said air vehicle further comprises additional propulsion means for reducing wander.

27. A coordinate measuring machine in accordance with claim 1 wherein said accurate measurements are accurate to better than 500 microns error.

28. A coordinate measuring machine in accordance with claim 1 wherein said probe is a tool for performing an operation on said object.

29. (canceled)

30. A method for accurately measuring an object in a coordinate measuring machine comprising the following steps:
[Step 1] a first measurement is made of an object using a probe and a localiser at a first probe location and orientation;
[Step 2] an air vehicle moves the probe to a second location and orientation;
[Step 3] a second measurement is made of the object using the probe and the localiser at the second location and orientation;
where steps 2 and 3 are repeated until measurements of the object have been made from all required locations and orientations.

31. A method for controlling the wander in flight of an air vehicle with main propulsion means and additional propulsion means in a coordinate measuring machine comprising the following steps:
[Step 1] the 6-DOF position and orientation of said air vehicle is measured using a localiser;
[Step 2] a control loop compares at least said 6-DOF position and orientation with at least the demanded 6-DOF position and orientation;
[Step 3] said control loop generates control output signals to the main propulsion means and additional propulsion means on said air vehicle to reduce said wander;
where steps 1 to 3 are repeated until the flight terminates.
